(19) United States
(12) Patent Application Publication
(10) Pub. No.: US 2014/0015675 A1
(43) Pub. Date: Jan. 16, 2014

(54) ANTI-THEFT TAG FOR EYEGLASSES

(71) Applicants: Shimi RAZ, Bat Hefer (IL); Guy HAYO, Hod Hasharon (IL)

(72) Inventors: Shimi RAZ, Bat Hefer (IL); Guy HAYO, Hod Hasharon (IL)

(73) Assignee: R.F Keeper Ltd., Rosh Ha'ain (IL)

(21) Appl. No.: 13/726,573

(22) Filed: Dec. 25, 2012

Related U.S. Application Data
(60) Provisional application No. 61/580,237, filed on Dec. 25, 2011.

(51) Int. Cl. G08B 13/24

(52) U.S. Cl. CPC G08B 13/2434
USPC 340/572.1

(57) ABSTRACT

An Electronic Article Surveillance (EAS) tag is removably mounted on a shaft of an eyeglasses temple to be protected. The EAS tag includes an elongated hollow arm member in which an EAS marker is stored. The EAS tag also includes a shaft holder member. The shaft holder member has several pairs of oppositely disposed openings on the circumference thereof to enable the holding of the eyeglasses having shafts with varied cross sections and widths. The arm member and the shaft holder member are coupled. A locking screw extending vertically through the front part of the elongated arm member right above the shaft holder is adapted to lock the shaft inserted through a selected pair of openings to the shaft holder. The locking screw has a special pattern on a head thereof. Locking or unlocking the shaft is accomplished by use of a special tool.

### FIELD OF THE INVENTION

The invention relates to theft deterent security tags in general, particularly to a security tag containg a marker for use in electronic article surveillance (EAS) system, and more particularly to a customer-friendly anti-theft security tag attachable to all types of eyeglasses or eyeglass frames put on sale that are having shafts of temples of diverse dimensions.

### BACKGROUND OF THE INVENTION

Diverse types of electronic article surveillance (EAS) systems are known having the common feature of employing a tag which is attached to an article to be protected against theft from a protected area, such as an article of merchandise from a commercial outlet such as a store. When a legitimate purchase of the article is made, the tag can be removed from the article. Such systems employ an EAS device detection assembly, commonly placed at all exits of a store, and if an activated tag is carried through the passageway controlled by the detection system, it is detected by the detection system and an alarm is actuated.

The detection tags have been developed to prevent this type of theft. Such detection tags are attached to the articles being protected in a manner which prevents easy removal by a thief. Typically, a special tool is required for removal which is provided only for authorized shop personnel. When using, theft detection tags, a surveillance device is located near the exits of the premises where articles are being sold. If an article, having an attached tag, is brought past a surveillance device, an alarm is triggered. The interaction between the tag and the surveillance device can be accomplished using a variety of technologies such as a tag with magnetic, microwave or radio frequency type. The surveillance device will then be of a type responsive to the particular type of energy.

Preventing theft of small articles, such as eyeglasses, in a retail environment is particularly difficult. A thief can simply wear on the body thereof the small article and thereby evade all but the most perceptive security personnel. Furthermore, a thief can quickly and easily hide a small article in a pocket, a pouch, a shopping bag or under the clothes thereof. Theft of small articles such as eyeglasses in retail establishments is prevalent problem which costs merchandisers millions of dollars every year in losses.

Furthermore, the detection tags generally in use today are not easily used with small articles. Small articles, such as eyeglasses have unique configurations that prevent traditional tags from being easily attached thereto. Moreover while tags having specifically configured attachment features have been designed for small articles, these specifically designed tags have attachment and removal means that are too awkward and slow to handle. Even so, today there is a widespread use of anti-theft tags applied on the frame of eyeglasses so that, if a dishonest customer leaves the shop without taking care of the deactivation of the tag, the tag causes a triggering of an alarm signal. At the current state of art various systems for supporting an anti-theft tag with respect to eyeglasses are used which use different methods for fixing it to the shaft of the temple of eyeglasses: from a simple strip to complex electromechanical mechanisms, based upon snap devices, through maneuvering, through personalized keys or threaded clamps.

There are several devices in the prior art which attempt to attach EAS tags to eyeglasses in order to reduce the monetary losses. As examples we quote the following patent documents:

U.S. Pat. No 5,097,540 issued to Narlow et al. discloses a tag having an adjustable loop for attachment to the temple of a pair of eyeglasses. The tag includes a tag device which secures the tag to the temple.

U.S. Pat. No. 5,119,652 issued to Costa discloses a tag which is folded over the temple of a pair of eyeglasses and locked, into place using a special locking element that must be broken to remove the tag.

U.S. Pat. No. 5,144820 issued to Holmgren discloses a tag which is attached to the temple of a pair of eyeglasses and held in place by means of a threaded screw device.

U.S. Pat. No. 5,437,172 issued to Lamy discloses a security hanger for eyeglasses which is secured to the bridge of the eyeglasses. The device requires a special tool for removal.

U.S. Pat. No. 6,330, 758 issued to Felbelman discloses a tag having a body, a prong and a tube constructed from material which shrinks when subjected to heat. In order to remove the tag from the eyeglasses the tube should be cut.

U.S. Pat. No. 4,431,394 issued to Girard discloses an anti-theft device that comprises a sleeve fitted on an arm of the eyeglasses. The sleeve abuts against the eyeglasses' frame and keeps the eyeglasses arm in its open position.

While all the aforementioned devices may be effective in deterring the theft of the eyeglasses they all have a number of drawbacks. Due to the complexity of the devices and the ways that they are attached to the eyeglasses, they are expensive to manufacture and therefore require that an authorized store clerk remove the devices at the point of sale or nearby. This removal requires special tools, so as prevent the removal of tags by a potential thief and results in increased checkout times. The devices also hamper the customer's ability to try on the eyeglasses, as the tags make it extremely difficult to properly seat the glasses on the customer's face. These devices have the problem of accommodating shafts having varied dimensions, such as the width thereof. Clamp-like devices may overcome this difficulty but typically include protrusions towards the inside of the shaft itself and cause trouble to customer's temple when he puts on the glasses to try them on.

What is needed therefore is an electric article surveillance tag which is smaller, lighter and simpler than the prior art devices and therefore inexpensive to manufacture. Furthermore, the required EAS device should be secured to the frame of a pair of eyeglasses effortlessly. Additionally the required EAS device should provide accommodation to different eyeglasses having different dimensions (i.e. width) of the shafts. The required devices should be adapted to be customer-friendly, i.e. should not interfere with the ability of the customer to try on the eyeglasses. The required device should also allow the authorized shop clerk or salesperson to detach the EAS tag from the eyeglasses quickly and with maximum ease.

### SUMMARY OF THE INVENTION

Accordingly, it is a general objective of the present invention to overcome the disadvantages of the prior art.

Therefore, it is a primary objective of the invention to provide an EAS tag that is smaller, lighter, simpler and less expensive than the prior art devices.

It is another objective of the invention to provide an EAS tag that is easily secured to a frame of a pair of eyeglasses.

It is a further objective of the invention to provide an EAS tag that accomodates different eyeglasses having shafts of different dimensions.

It is still a further objective of the invention to provide an EAS tag that will not interfere with the ability of a customer to try on the eyeglasses with the EAS tag attached thereto.

It is yet a further objective of the present invention to provide an EAS tag that allows an authorized shop clerk or salesperson to detach the EAS tag quickly and effortlessly from the eyeglasses.

It is yet a further objective of the present invention to provide an EAS tag with mechanical locking and unlocking features but which cannot be removed by the customer and can be retained on the shaft of the temple when the eyeglasses or the eyeglass frame protected against theft is tried on

In keeping with the principles of the present invention, a unique EAS theft deterent tag is presented for eyeglasses and eyeglass frames. The anti-theft device is a type of Electronic Article Surveillance (EAS) tag used for the prevention of theft it is attachable to all types of eyeglasses and eyeglass frames. The ESA tag is removably mounted on a shaft of a temple of an eyeglass. The ESA, tag includes an elongated hollow arm member into which an ESA marker or target is inserted. The ESA tag also includes a shaft holder member. The shaft holder member is disposed at the front end and under the elongated arm member and rotatably connected to the elongated arm member. The shaft holder member is having two or more pairs of oppositely disposed openings on the circumference thereof to enable the holding of the eyeglasses having shafts with varied widths. The arm member and the shaft holder member are coupled rotatably. A locking screw that extends vertically through the front part of the elongated arm member right above the shaft holder, is adapted to lock the shaft inserted through a selected pair of openings in the shaft holder. The locking screw has a special pattern on the head thereof. The release of the locking or unlocking of the shaft is accomplished by the use of a special tool. The ESA tag of the invention is of the type comprising a body to be clamped to the shaft of the temple of the eyeglass or the eyeglass frame where the clamping means are operated manually by means of a special tool that could be screwdriver-like or key-like when the body of the ESA tag is to be mounted or demounted. The ESA tag is provided with an ESA marker or a target which is an electronic sensor affecting the anti-theft system.

The main aspect of the present invention concerns an anti-theft tag for the protection of eyeglasses and eyeglass frames against theft. The anti-theft tag is attached to eyeglasses and eyeglass frames. The anti-theft tag includes: an elongated arm being provided with a sensor to indicate the presence thereof to a surveillance system in an interrogation field, a shaft holder having an open frame configuration and a shaft clamp plate within the open space of the shaft holder. The shaft holder also joined to the arm, and is having two or more pairs of oppositely disposed openings on the circumference thereof to receive selectively one shaft of the temple of the eyeglasses or eyeglass frames through one pair of the oppositely disposed openings in accordance with the width of the shaft and to be clamped to one shaft of the eyeglasses and the eyeglass frames. The anti-theft tag further includes a screw having a head with a socket to be engaged by a complementary projection on the tip of a locking and unlocking tool, the screw is having a external thread. The screw fastens the arm to the shaft holder, and it is driven against the shaft clamp plate, to clamp the shaft between the shaft clamp plate and an inner lower surface of the shaft holder. The anti-theft tag further includes a locking and unlocking tool having a handle and an axial shaft. At the end of the axial shaft a projection complementary to the socket is formed. The tool engages the socket; the tool applicable to the socket to turn the screw and drive the screw downward or upward to clamp and release the shaft clamp plate to the shaft, respectively. Therefore when the shaft is clamped to the shaft holder and held tight between the shaft clamp plate and the inner surface of the shaft holder. Such stated objects and advantages of the invention are only examples and should not be construed as limiting the present invention. These and other objects, features, aspects and advantages of the invention herein will become more apparent from the following detailed description of the embodiments of the invention when taken in conjunction with the accompanying drawings and the claims that follow.

### BRIEF DESCRIPTION OF THE DRAWINGS

The invention herein described, by way of example, with reference to the accompanying drawings, wherein;

FIG. 1A is a side elevation view of the ESA tag in accordance with the first preferred embodiment of the present invention;

FIG. 1B is a top view of the ESA tag, in accordance with the first preferred embodiment of the present invention;

FIG. 1C is a front elevation view of the ESA tag in accordance with the first preferred embodiment of the present invention;

FIG. 1D is a side elevation view of the ESA tag, in accordance with a first preferred embodiment of the present invention;

FIG. 2A is a side elevation view of the ESA tag, in accordance with the second preferred, embodiment of the present invention;

FIG. 2B is a top view of the ESA tag, in accordance with the second preferred embodiment of the present invention;

FIG. 2C is a front elevation view of the ESA tag, in accordance with the first preferred embodiment of the present invention;

FIG. 3A is a bottom elevation view of the ESA tag, in accordance with the third preferred embodiment of the present invention;

FIG. 3B is a front elevation of the ESA tag, in accordance with the third preferred embodiment of the present invention;

FIG. 3C is a top elevation view of the ESA tag, in accordance with the third preferred embodiment of the present invention;

FIG. 3D is top view of the ESA tag, in accordance with the third preferred embodiments of the present invention;

FIG. 4A is a top elevation view of the ESA tag with a locking and unlocking tool, in accordance with the preferred embodiments of the present invention;

FIG. 4B is a top elevation view of the ESA tag with an alternative locking and unlocking tool, in accordance with the preferred embodiments of the present invention; and

FIG. 5 is a partially exploded view of the ESA tag, in accordance with the preferred embodiments of the present invention.

It should to be understood that the foregoing drawings and the description below, are provided primarily for purposes of facilitating understanding the conceptual aspects of the invention and various possible embodiments thereof; including what are now considered to be preferred embodiments. It is to be further understood that the embodiments described are for purposes of example only, and that the invention is capable of being embodied in other forms and applications than those described below.

### DETAILED DESCRIPTION OF THE PREFERRED EMBODIMENTS

The invention relates to an anti-theft device for eyeglasses and eyeglass frames intended for use in commercial outlets, such as supermarkets, department stores and opticians shops to prevent persons from walking out with eyeglasses or an eyeglass frame without having paid for the merchandise. The anti-theft device is a type of Electronic Article Surveillance (EAS) tag used for the prevention of theft. The ESA tag is attachable to all types of eyeglasses. The putting on of the eyeglasses with the ESA tag attached thereto is convenient to a user when the user wishes to try the eyeglasses on prior to the purchaser. The ESA tag is removably mounted on a shaft of a temple of the eyeglasses. The ESA tag includes an elongated hollow arm member into which an ESA marker or target is inserted. The ESA tag also includes a shaft holder member. The shaft holder member is disposed at the front end and under the elongated arm member and rotatably connected to the elongated arm member. The shaft holder member is having two or more pairs of oppositely disposed openings on the circumference thereof to enable the holding of the eyeglasses having shafts with varied characteristics, such as circular cross section and width. The arm member and the shaft holder member are coupled rotatably by a locking screw. The locking screw extends vertically through a first threaded hole formed in the forward part of the elongated arm member and it is disposed right above the shaft holder which is having a similarly formed second threaded hole which lies in-line with the first threaded hole. The locking crew is adapted a) to lock the arm member and the shaft holder member together and b) to lock the shaft inserted through a selected pair of openings in the shaft holder. The locking screw has a special pattern on the head thereof and a hollow socket having an interior-of-sphere shape on the tip thereof. The shaft holder member includes a shaft clamp plate which is having a sphere-shaped protuberance on a surface thereof that faces the tip of the locking screw. The locking of the arm member and the shaft holder member and the release of the locking or unlocking of the shaft is accomplished by the use of a special tool.

More particularly, the ESA tag of the invention is of the type comprising a body to be clamped to the shaft of the temple of the eyeglasses. The clamping means can be operated manually by means of the above mentioned special tool when the body of the ESA tag is to be mounted or demounted. The ESA tag is provided with an ESA marker or a target which is an electronic sensor affecting the anti-theft system. Anti-theft tags that utilize purely mechanical locking and unlocking are well known. Typical mechanical locking systems involve a body which is clamped to the shaft of the temple whereby the shaft will be held in the common position of useage (open) and cannot be folded against the rest of the eyeglass frame. Such a purely mechanical ESA tag is bulky, unwieldy, relatively heavy and most importantly prevents the eyeglasses from being tried on by a customer. Said customer can only try on the eyeglasses after an authorized personnel removes the ESA tag temporarily. Alternatively the ESA tag can be designed such that the removal of the ESA tag is a simple, straightforward procedure hence a customer could do it without assistance. Adapting ESA tags for easy removal from the eyeglasses though is self-defeating since a shoplifter could remove the ESA tag as readily as a regular customer. Therefore, an objective of the present invention is to provide an anti-theft tag with mechanical locking and unlocking features but which cannot be removed by the customer and can be retained on the shaft of the temple when the eyeglasses or the eyeglass frame protected against theft is tried on An additional objective of the present invention is to provide an ESA tag that could be easily handled by the shop personnel.

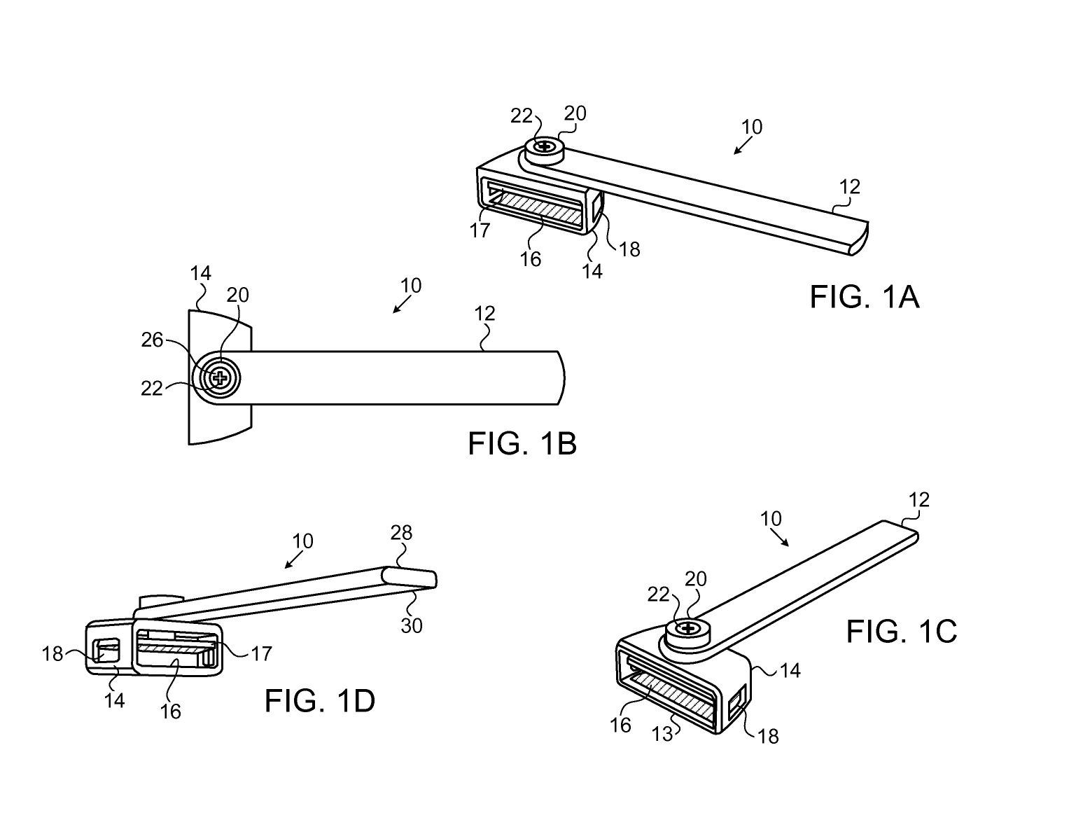

Referring now to FIGS. 1A and 1D the anti-theft device or the ESA tag 10 comprises a hollow arm 12 which is formed by two complimentary elongated wide U-shaped panels 28 and 30 of FIG. 1D. The two panels 28 and 30 enclose an inner space of the arm 12 where an ESA marker or target (not shown) is placed into the inner space of the arm 12. The arm 12 is provided with a first threaded hole formed in the body of the arm 12, and extending vertically downward (not shown). The first threaded hole is provided with an internal threading (not shown) to enable the external thread of the screw 22 to engage the complementary internal thread of the first hole and thereby beginning the operation of fastening the arm 12 to the shaft holder 12. The screw 22 is provided preferably with a round head and an adjoining shank. The head of the screw 22 could have many different forms such as pan head, button head, truss head, flat head, oval head and the like.

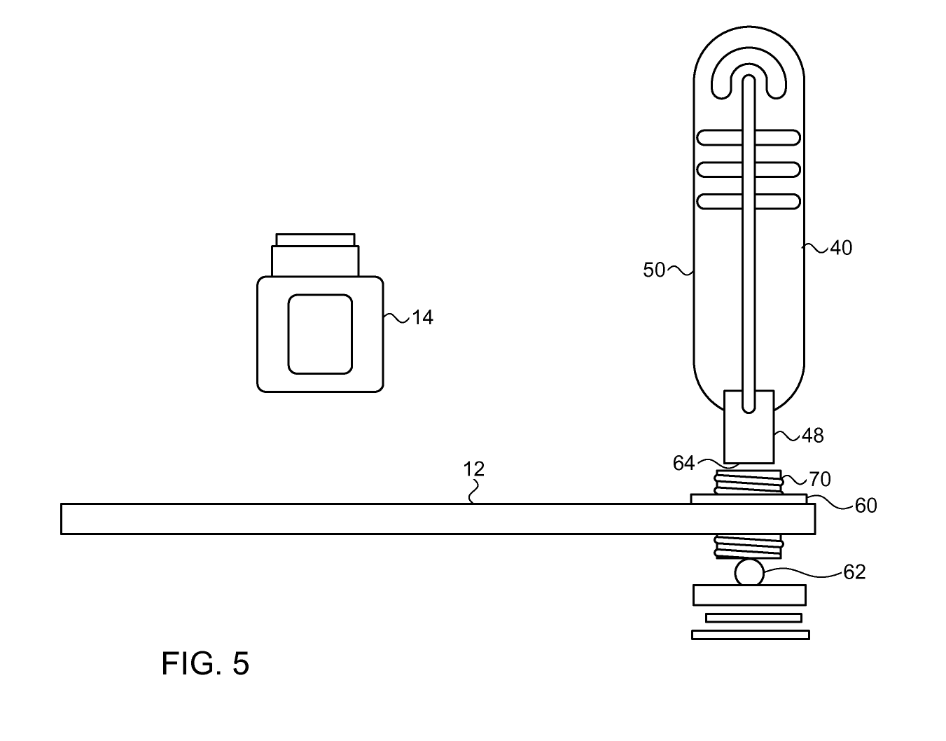

Referring to FIG. 1A and 5 in the first preferred embodiment of the invention, the shaft holder member 14 has a trapezoid-like shape. The shaft holder 14 is an open frame with two pairs of oppositely disposed openings 16 and 18 starting and terminating at the circumference. The pair of openings 16 and 18 each have particular and different cross sections and diameters to accommodate different shafts having differing cross sections and widths. In the first preferred embodiments of the invention, the two pairs of openings 16 and 18 are disposed with respect to each other by 90 degrees on the vertical plane. Shaft holder 14 further includes a second threaded hole (not shown) which lies in-line with the first threaded hole of the arm 12. The screw 22 is inserted through the first threaded hole in the arm 12 and the second threaded hole in the shaft holder 14 where the external threading of the screw 22 engages the complimentary internal threadings of the first and second holes and fastened into the upper surface of a shaft clamp plate 17 disposed within the open frame of the shaft holder, shaped in a rectangle-like manner and is disposed in close proximity with the inner upper surface of the shaft holder 12. The fastening of the screw 22 to the shaft clamp plate 17 is provided by an integral sphere-shaped portuberance 70 of FIG. 5 located on the upper surface of the shaft clamp plate 17 in-line with the second threaded hole, the first threaded hole and facing the hollow socket on the tip of the screw 22.

Referring to FIG. 1A screw 22 is a headed, threaded, tapered fastener and it is designed to be used in conjunction with the complementary internal threads. In order to clamp the ESA tag 10 to a shaft of an eyeglass or an eyeglass frame, the shaft is inserted selectively through one of the two oppositely disposed openings 16 or 18. The selection of the pair of opening 16 and 18 is made in accordance with the characteristics of the arm 12, such as cross section and width. The selection of one of the two pair of oppositely disposed openings 16 or 18 is made by rotating the shaft holder 14 through 90 degrees such that turning one of the two pair of openings 16 and 18 to lie in parallel to the arm 12 in the horizontal plane. Then, the shaft of the temple of the eyeglass or eyeglass frame (not shown) to be protected is inserted through the selected pair of openings, 16 or 18 respectively, as far forward towards the butt-strap of the temple, as desirable. Consequent to the insertion of the shaft through the pair of openings 16 or 18, the lower surface of the arm 12 is in close proximity to the inner surface of the shaft and extends in parallel to the shaft along the inner surface of the shaft in the horizontal plane. In order prevent movement of the shaft the screw 22 is then driven downward and thereby drives the shaft clamp plate 17 to a close contact with the shaft of the eyeglasses. The lower surface of the shaft clamp plate 17 is preferably made of a soft material or covered with a soft material to prevent damage to the shaft, such as scratches, deformations and the like. The screw 22 is driven downward by the turning of the screw 22 by a special tool. The figure discussed shows that the orientation of shaft holder 14 is such that the pair of holes 18 facing along the arm 12 parallel to it in the horizontal plane and therefore ready to accept the shaft of the temple for insertion.

FIG. 1B shows the top view of the EAS tag. The head of screw 22 has a slot 26 that is a cross-like (Frearson type) shaped socket that accepts a cross-like shaped projection on the tip of a special tool, such as a screwdriver-like tool. The screwdriver-like tool engages with the head of the screw 22 and allows torque to be applied to turn the screw 22, thus driving it in or loosening it The projection on the screwdriver-like tool tip engages the cross-like socket 26 on the screw head and thereby the turning of the screw 22 is enabled in both clockwise and anti-clockwise direction. The torque provided by the turn of the screw 22 is translated into a linear force downward and upward, respectively. Both the socket 26 of the screw 22 and the complimentary projection on the screwdriver-like tool could have a variety of shapes, such as a Phillips shape, an Allen shape (hex), a slotted shape, a Roberston shape, a Torx shape, a Pozi Div type shape, a Bristol type shape and the like. In the preferred embodiments of the invention the shape of the socket 26 and the complementary projection on the screwdriver-like tool tip is preferably of an unusual type (e.g. a Triple Square typeshape or a Torx-Set type shape) to make it difficult to a shoplifter to remove the EAS tag consequent to the bringing along of a screwdriver-like tool with a commonly used socket type on the head. Furthermore, for enhanced protection a specifically designed unusual shape could be used.

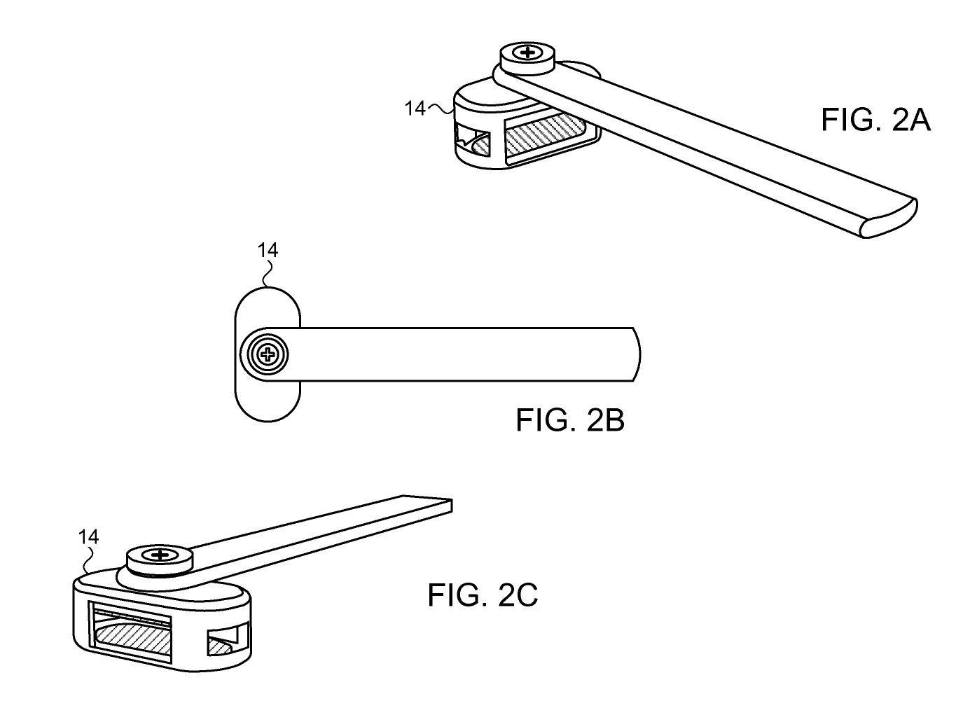

Referring now to FIGS. 1C and 1D, the lower inner surface of the shaft holder 14 is padded with a layer of soft material to prevent damage to the shaft of the temple of the eyeglasses when clamped against the lower inner surface of the shaft holder 14. In comparison with FIG. 1A in FIGS. 1B, 1C, and 1D the shaft holder 14 is rotated 90 degrees in the clockwise direction, such that the pair of openings 16 and 18 is facing along the arm 12 and lies in parallel to the arm 12 on the horizontal axis and therefore the pair of openings 16 and 18 is ready to accept the shaft of the temple for insertion. Referring now to FIGS. 2A, 2B and 2C in the second preferred embodiment of the present invention the shaft holder 14 is provided with a rectangle-like shape with the four corners of the rectangle rounded to provide more convenient handling.

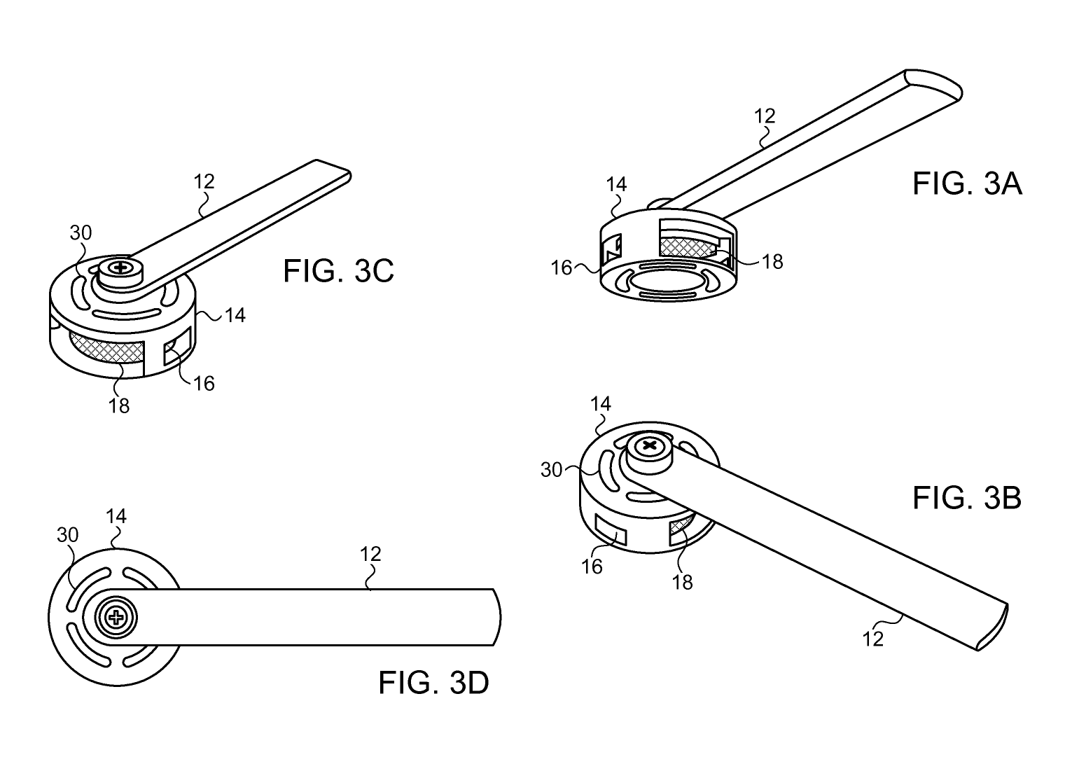

Referring now to FIGS. 3A, 3B, 3C and 3D, in the third preferred embodiment of the present invention the shaft holder 14 is provided with an annular shape. In addition, top openings 30 are provided on top of the shaft holder 14 where each of the top openings 30 is corresponding to each of the openings comprising the pair of openings 16 and 18. The top openings 30 provide a better visual control to the authorized personnel attaching the ESA tags to eyeglasses when rotating the shaft holder 14 in order to set a specific pair of holes 16 or 18 such as to face the arm 12 and to lie in parallel to the arm 12 on the horizontal axis.

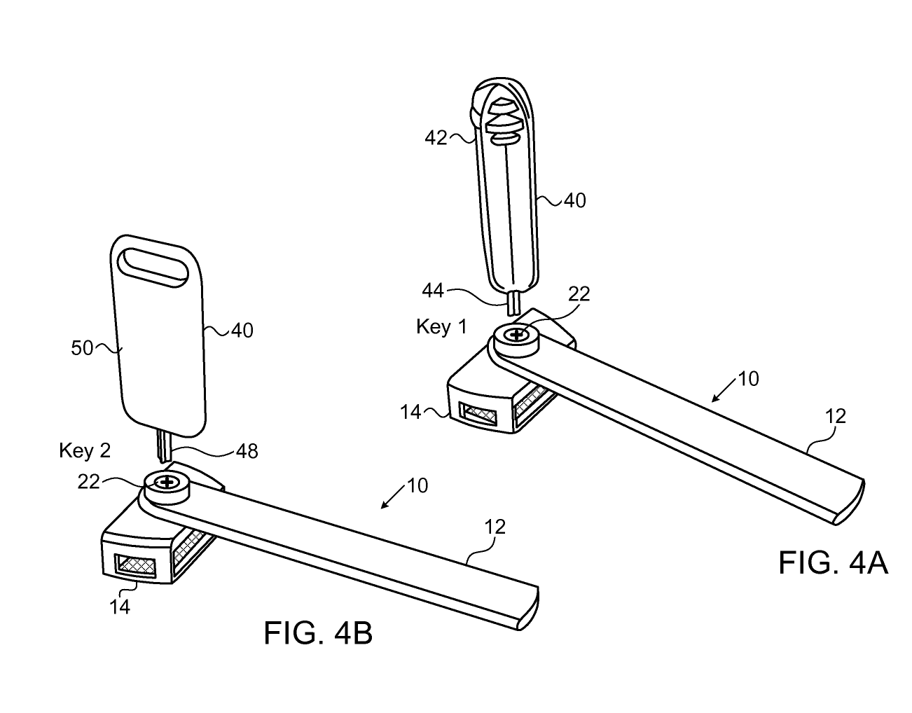

Referring now to FIGS IA and 4A, FIG. 4A shows the ESA device 10 with a special tool 40 to lock and unlock the ESA tag 10 from the shaft of the temple of the eyeglass (not shown) to be protected against theft. In the preferred embodiment of the invention the special tool 40 is a conventional manual screwdriver. The screwdriver 40 comprises an approximately cylindrical handle 42, and an axial shaft 44 fixed to the handle 42, the tip or head of which contains a projection shaped to fit a particular type of screw 22. The handle 42 of the screwdriver 40 and the shaft 44 of the screwdriver 40 allow the screwdriver 40 to be positioned, supported and, when rotated, to apply torque. The tip or head of the shaft 44 has been adapted for slotted screws. In order to lock or unlock the ESA tag 10 to or from the shaft of the temple, the screwdriver 40 is positioned such that the projection on the head thereof engages the socket on the screw 22 and the screwdriver 40 is turned in the clockwise or the anti-clockwise direction, respectively. The turning creates a torque force that is translated to a linear force which is applied vertically downward or upward, respectively, to the screw head. The turning of the screw 22 clockwise drives the screw 22 downward and a) secures the arm 12, the shaft holder 14 and shaft clamp plate 17 of FIG. 1A and b) pushes the shaft clamp plate 17 of FIG. 1A against the shaft of the temple until the shaft is clamped strongly between the shaft clamp plate 17 of FIG. 1A and the lower inner surface 19 of the shaft holder 14. The turning of the screw 22 anti-clockwise drives the screw 22 upward and a raises the shaft clamp plate 17 of FIG. 1A until the shaft clamp pale 17 looses contact with the shaft of the temple. Then, the shaft could be readily removed from the ESA tag 10.

Referring now to FIGS. 1A and 4B, FIG. 48 shows an alternative embodiment of the present invention where the special tool is a key-like tool 46. A typical key includes a blade 48, which slides into the passageway of a lock and and the bow 50, which is left protruding so that torque can be applied by a user. In the alternative embodiment of the present invention, the key-like tool 46 is used in a different manner when functionally the bow 50 replaces the handle 42 of the screwdriver 40 and the blade 48 replaces the axial shaft 44 of the screwdriver 40. On the tip of the blade 48 a complementary projection is shaped to engage the socket of the head of the screw 22. In order to lock or unlock the ESA tag 10 from the shaft of the temple the key-like tool 46 is positioned such that the projection on the tip engages the socket on the screw 22 and the key-like tool 46 is turned in the clockwise or the anti-clockwise direction, respectively. The turn creates a torque force that is translated to a linear force which is applied vertically downward or upward in the vertical plane; respectively, to the screw head. The turning of the screw 22 clockwise drives the screw 22 downward and a) secures the arm 10, the shaft holder 14 and the shaft clamp plate 17 of FIG. 1A and b) pushes the shaft clamp plate 17 of FIG. 1A against the shaft of the temple until the shaft is clamped strongly between the shaft clamp plate 17 and the lower inner surface 16 of the shaft holder 14. The turning of the screw 22 anti-clockwise drives the screw upward and a raises the shaft clamp plate 17 until the shaft clamp pale 17 looses contact with the shaft of the temple. Then, the shaft could be readily removed from the ESA tag 10.

Referring now to FIGS. 1A and 5 the anti-theft tag 10 is received at the point of sale with the arm 12, the shaft holder 14 and the shaft clamp plate 17 of FIG. 1A already locked together. The arm 12 and the shaft holder 14 are held together by the screw 70 which was driven through the first and second threaded holes. The shaft clamp plate 14 is locked to the screw 70 by the sphere-shaped protuberance that is received by the interior of sphere-shaped hollow socket on the tip of screw 22. The locking of the protuberance 70 in the hollow socket is achieved by friction. As a result of the shape of the protuberance and the complimentary shape of the hollow socket the shaft clamp holder 14 is denied freedom of vertical and horizontal movement but allowed circular freedom of movement around the vertical axis thereof When the locking of the shaft of the temple is desired, the screw 22 and the shaft clamp plate 17 of FIG. 1A are driven vertically downward until the shaft of the temple is clamped between the inner lower surface of the shaft clamp plate 17 of FIG. 1A and the inner lower surface of the shaft holder 14. A nut 20 is disposed at the head of the screw 22 to prevent movements of the screw 22.

It would be easily perceived that although in the first, second and third embodiments of the present invention only two pairs of openings were described and presented, in other preferred embodiments of the present invention more than two pairs of openings could be utilized to accommodate more than two types of eyeglasses with shafts of the temples differing in cross section and width.

Inside of the arm an EAS marker or target is located. The ESA marker (not shown) is a sensor of the type affecting a magnetic, acoustic or electromagnetic field maintained between two or more antennas at the exit of the shop to disturb the electromagnetic field and cause an alarm signal generation to indicate that the article bearing the EAS marker may not have been paid for or properly checked out.

It would be readily perceived that although the above description and the above graphical presentation of the ESA tag of the present invention focuses on articles of merchandise, such as eyeglasses or eyeglass frames to which the ESA tag could be attached and therey to protect it in other embodiments of the invention the protected merchandise could be any article that have a prong-like protrusion on which the ESA tag could be clamped in order to provide electronic antipilfering protection.

While the invention has been described primarily with respect to the three preferred embodiments, it will be appreciated that these are set forth merely for purposes of example, and that the invention can be implemented with many other structures. Changes may be made in the construction and operation of various components, elements and assemblies described herein without departing from the spirit and scope of the invention as defined in the following claims.

1. Anti-theft tag for the protection of eyeglasses against theft, said anti-theft tag is attached to said eyeglasses, said anti-theft tag comprising:
a. an elongated arm being provided with a sensor to indicate the presence of said sensor to a surveillance system in an interrogation field;
b. a shaft holder having an open frame configuration, said shaft holder is having a shaft clamp plate within the open space of said shaft holder, said shaft clamp plate having an integral sphere-shaped protuberance on the upper surface of said shaft clamp plate, said shaft holder is joined to said arm, said shaft holder is having two or more pairs of oppositely disposed openings on the circumference thereof to receive selectively one shaft of the temple of said eyeglasses through one pair of said oppositely disposed openings in accordance with characteristics of said shaft, said eyeglasses to be clamped to said one shaft of said anti-theft tag;
c. a screw having a head with a socket to be engaged by a complementary projection on the tip of a locking and unlocking tool, said screw having an interior of sphere-shaped hollow socket on the tip thereof to receive said sphere-shaped protuberance, said screw is having an external thread said internal thread fastens said arm to said shaft holder, said external thread drives said screw against said shaft clamp plate, to clamp said shaft between said shaft clamp plate and an inner surface of said shaft holder;
d. a locking and unlocking tool having a handle, said tool is having an axial shaft at the end of said axial shaft a projection complementary to said socket, said tool engages said socket; said tool applicable to said socket to turn said screw and drive said screw downward or upward to clamp and release said shaft clamp plate to said shaft, respectively; whereby the shaft is clamped to said shaft holder and held tight between said shaft clamp plate and said inner surface of said shaft holder.

2. The anti-theft tag of claim 1 said one pair of openings are arranged to receive said shaft by rotating said shaft holder until said pair of openings are in-line with said shaft.

3. The anti-theft tag of claim 1 wherein said shaft holder frame having a trapezoid-like form.

4. The anti-theft tag of claim 3 wherein said shaft holder frame having a rectangle-like form.

5. The anti-theft tag of claim 4, wherein said shaft holder frame having an annular form.

6. The anti-theft tag of claim 1, wherein said screw is driven in the downward direction vertically, said screw loosened in the upward direction vertically through a first threaded hole in the body of said arm, a second threaded hole in the body of said shaft holder, said hollow socket on the tip of the screw receives said sphere-shaped protuberance integral to said shaft holder plate.

7. The anti-theft tag of to claim 1, wherein the locking and unlocking tool is a screwdriver-like tool.

8. The anti-theft tag of claim 7, wherein the locking and unlocking tool is a key-like tool.

9. The anti-theft tag of claim 1, wherein said socket on said head of said screw is having a Phillips pattern.

10. The anti-theft tag of claim 9, wherein said socket on said head of said screw is having an Allen pattern.

11. The anti-theft tag of claim 10, wherein said projection pattern on said head of said locking and unlocking tool is complementary to said pattern on said head of screw.

12. The anti-theft tag of claim 1 wherein said surveillance system is an electronic article surveillance (EAS) system.

13. The anti-theft tag of claim 1, wherein said sensor is an electronic article surveillance (ESA) marker adapted to respond to an electromagnetic field.

14. The anti-theft tag of claim 1, wherein said shaft holder having top openings the size of said top openings corresponding to said openings on the circumference of said shaft holder.

15. The anti-theft tag of claim 1, wherein said chacteristics of said shaft include width.
